(19) United States
(12) Patent Application Publication
(10) Pub. No.: US 2015/0137783 A1
(43) Pub. Date: May 21, 2015

(54) Method, Apparatus and System For Controlling An Electrical Load

(71) Applicant: SCHNEIDER ELECTRIC SOUTH EAST ASIA (HQ) PTE LTD, Techpoint (SG)

(72) Inventors: Arash Boora, New South Wales (AU); Aleksander Roman Stelmach, New South Wales (AU)

(21) Appl. No.: 14/401,783

(22) PCT Filed: May 16, 2013
(86) PCT No.: PCT/AU2013/000503

§ 371 Date: Nov. 17, 2014

(30) Foreign Application Priority Data
May 16, 2012 (AU) 2012902012

(51) Int. Cl. H02M 3/156; H05B 37/02

(52) U.S. Cl. CPC H02M 3/156; H05B 37/02
USPC 323/282

(57) ABSTRACT

Disclosed is a system, apparatus and method for controlling an electrical load. A bypass device is provided in parallel with the electrical load, which in use, adopts a high conduction or low impedance state when a controller controlling the electrical load is in a low conduction or off state. In one embodiment, the bypass device comprises a detector for detecting the conduction state of the controller, and a bypass control for controlling the impedance of the by-pass device in response to the detected state of the controller.

### TECHNICAL FIELD

The present application relates to the control of electrical loads such as lighting.

### PRIORITY CLAIM

The present application claims priority from Australian Provisional Patent Application No. 2012902012 entitled “Method, Apparatus and System for Controlling an Electrical Load”, filed on 16 May 2012.

The entire content of this application is hereby incorporated by reference.

### INCORPORATION BY REFERENCE

The following documents are referred to in the present application:
PCT/AU03/00365 entitled “Improved Dimmer Circuit Arrangement”;
PCT/AU03/00366 entitled “Dimmer Circuit with Improved Inductive Load”;
PCT/AU03/00364 entitled “Dimmer Circuit with Improved Ripple Control”;
PCT/AU2006/001883 entitled “Current Zero Crossing Detector in A Dimmer Circuit”;
PCT/AU2006/001882 entitled “Load Detector For A Dimmer”;
PCT/AU2006/001881 entitled “A Universal Dimmer” ;
PCT/AU2008/001398 entitled “Improved Start-Up Detection in a Dimmer Circuit”;
PCT/AU2008/001399 entitled “Dimmer Circuit With Overcurrent Detection”;
PCT/AU2008/001400 entitled “Overcurrent Protection in a Dimmer Circuit”; and
Australian Provisional Patent Application No 2011904151 entitled “Dimmable Light Emitting Diode Load Driver with Bypass Current”.

The entire content of each of these documents is hereby incorporated by reference.

### BACKGROUND

Electrical loads that may be controlled in an electrical load control system include lights (including Compact Fluorescent Lamps (CFLs) and Light Emitting Diode (LED) lamps), fans and motors. One method of controlling such loads is by use of a controller such as a phase control dimming circuit.

Phase control dimming circuits (also referred to as dimmer circuits or simply dimmers) are used to control the power provided to the load from a power source such as supply or mains power.

Specifically, the power control is the control of the electrical current provided by the power source. Such circuits often use a technique referred to as phase control dimming. This allows power provided to the load to be controlled by varying the amount of time that a switch connecting the load to the power source is conducting during a given cycle.

For example, if voltage provided by the power source can be represented by a sine wave, then maximum power is provided to the load if the switch connecting the load to the power source is on at all times. In this way, the total energy of the power source is transferred to the load (minus usual losses as will be understood by the person skilled in the art). If the switch is turned off for a portion of each cycle (both positive and negative), then a proportional amount of the sine wave is effectively isolated from the load, thus reducing the average energy provided to the load. For example, if the switch is turned on and off half way through each cycle, then only approximately half of the power will be transferred to the load. If the load is a light, this results in the light exhibiting a reduced luminosity. If the point of the switching during each cycle is varied over time, the overall effect will be, for example in the case of a light, a smooth dimming action resulting in the control of the luminosity of the light.

FIG. 1 shows a typical electrical load control system 100 for controlling power to a load 20, and thus controlling the load itself. The control system 100 is connected to a power supply or source 10, which in a typical case, is mains or supply power, but could be any other suitable power source. Connected in series with load 20 is a controller 30, such as a dimmer circuit. As described above, controller 30 will control the amount of power delivered to load 20 from power source 10.

Some electrical loads are susceptible to unintended stimulation by leakage currents when the dimmer or controller is switched off (i.e. is not conducting), particularly in controllers that use electronic switching to switch to the off-state or non-conducting state. Symptoms of such unintended stimulation include intermittent illumination of the load in the case of a light or unintended erratic actuation of a fan or motor. Additionally control of some loads across the entire control range can be impaired by the varying impedance of the load.

FIG. 2 shows a general configuration of a typical complex electrical load 20 such as a Light Emitting Diode (LED) or Compact Fluorescent Lamp (CFL) lamp. The load 20 is connected to power source 10 via connections 24a and 24b. Input capacitor 25 is typically connected across connections 24a, 24b which are further connected to the input of rectifier 21. Voltage output of the rectifier 21 is typically connected to the reservoir capacitor 26 providing a power supply for internal load control electronics 22 which drive, for example a Compact Fluorescent tube or Light Emitting Diode 23. It will be appreciated that in these cases, the “electrical load” comprises the main load such as an LED or CFL with additional electronic elements to support its operation in use.

FIGS. 3A and 3B show typical voltage waveforms across a controller 30 (for example a dimmer or dimmer circuit) in series with a typical complex electrical or electronic load such as described above. FIG. 3A shows the voltage waveform across the dimmer, while FIG. 3B shows the voltage waveform across the load, as the waveform from the power source varies over its cycles. It will be noted that the voltage across the load does not immediately fall to zero when the drive to it is switched off. The point of switch off is indicated as point 11 in FIG. 3A. As described above, such behaviour may contribute to control difficulties within the dimming circuit such as zero crossing 12 detection and reduction of available power for internal dimmer operation.

In the past, some of these problems have been attempted to be addressed by the provision of a conductive element in parallel with the load (sometimes referred to as a “bypass” element). Such elements include a low power incandescent lamp or an equivalent resistor, optionally with a positive temperature coefficient, or a capacitor. These arrangements however, can suffer from a number of drawbacks including excessive power dissipation, and reactive elements such as capacitors can impair the ability of an associated dimmer to locate critical points in the power waveform such as zero crossing.

### SUMMARY

In one aspect, there is provided a bypass device for use in an electrical load control system comprising the electrical load and a controller for controlling power provided to the electrical load from a power source, the bypass device for connection in parallel with the electrical load, the bypass device comprising:
a detector for detecting when the controller is in a low conduction or off state; and
a bypass control for causing the bypass device to adopt a low impedance state when the detector detects that the controller is in the low conduction or off state.

In one form, the bypass device further comprises input terminals and wherein the detector comprises a high frequency component detector for detecting via the input terminals, high frequency components in a waveform of a voltage signal across the load.

In one form, the bypass control comprises a voltage limiter to limit the voltage across the input terminals of the bypass device to a maximum voltage value when the detector detects that the controller is in the low conduction or off state.

In one form, the bypass device further comprises a power source unit for providing power to at least one of the detector and the bypass control.

In one form, the detector is also for detecting when the controller is in a high conduction or on state and wherein the bypass control is also for causing the bypass device to adopt a high impedance state when the controller is in the high conduction or on state.

According to a second aspect, there is provided an electrical load control system for controlling power provided to the electrical load, comprising:
the electrical load;
a controller for controlling power provided to the electrical load from a power source; and
a bypass device in parallel with the electrical load wherein the bypass device is adapted to adopt a low impedance state when the controller is in a low conduction or off state.

In one form, the bypass device is adapted to adopt a high impedance state when the controller is in a high conduction or on state.

In one form, the controller is a phase control dimmer circuit.

In a third aspect, there is provided a method of controlling power delivered to an electrical load in an electrical load control system comprising the electrical load, a controller for controlling the power provided to the load, and a bypass device in parallel with the electrical load, the method comprising; ,
detecting when the controller is in a low conduction or off state; and
causing the bypass device to adopt a low impedance state when the controller is detected to be in the low conduction or off state.

In one form, the step of detecting when the controller is in a low conduction or off state comprises detecting the presence of high frequency components in the waveform of a power signal across the electrical load.

In one form, the step of causing the bypass device to adopt a low impedance state comprises limiting the voltage across input terminals of the bypass device to a maximum voltage value.

### BRIEF DESCRIPTION OF THE DRAWINGS

Various aspects are herein described with reference to the following drawings in which:

FIG. 1—shows a typical prior art electrical load control system;

FIG. 2—shows a general configuration of a typical complex electrical load;

FIG. 3A—shows the voltage waveform across the controller in the arrangement of FIG. 1;

FIG. 3B—shows the voltage waveform across the load in the arrangement of FIG. 1;

FIG. 4A—shows an arrangement of an electrical load control system according to one aspect described herein;

FIG. 4B—shows the arrangement of FIG. 4A in use connected to a power supply;

FIG. 5—shows one embodiment of the detector, in the bypass device of FIGS. 4A and 4B;

FIG. 6—shows another embodiment of the detector in the bypass device of FIGS. 4A and 4B incorporating a power supply;

FIG. 7A—shows a voltage waveform appearing between the terminals of the bypass device upon the controller changing states;

FIG. 7B—shows the control signal generated upon detection of high frequency components in the waveform of FIG. 7A;

FIG. 7C—shows the current limiting through the bypass control in response to the control signal of FIG. 7B;

FIG. 8A—shows the voltage waveform across the bypass device;

FIG. 8B—shows the impedance of the controller as the waveform of FIG. 8A varies;

FIG. 8C—shows the impedance of the bypass device as the impedance of the controller varies;

FIG. 9A—shows one embodiment of a circuit arrangement for the bypass device;

FIG. 9B—shows another embodiment of the circuit arrangement for the bypass device using a digital implementation;

FIG. 10A—shows the waveform of the voltage signal across the controller when the bypass device is used as shown in FIGS. 4A and 4B;

FIG. 10B—shows the waveform of the voltage signal across the electrical load when the bypass device is used as shown in FIGS. 4A and 4B;

FIG. 11—shows a flowchart of a general method according to one embodiment disclosed; and

FIG. 12—shows a flowchart of one embodiment of the general method of FIG. 11;

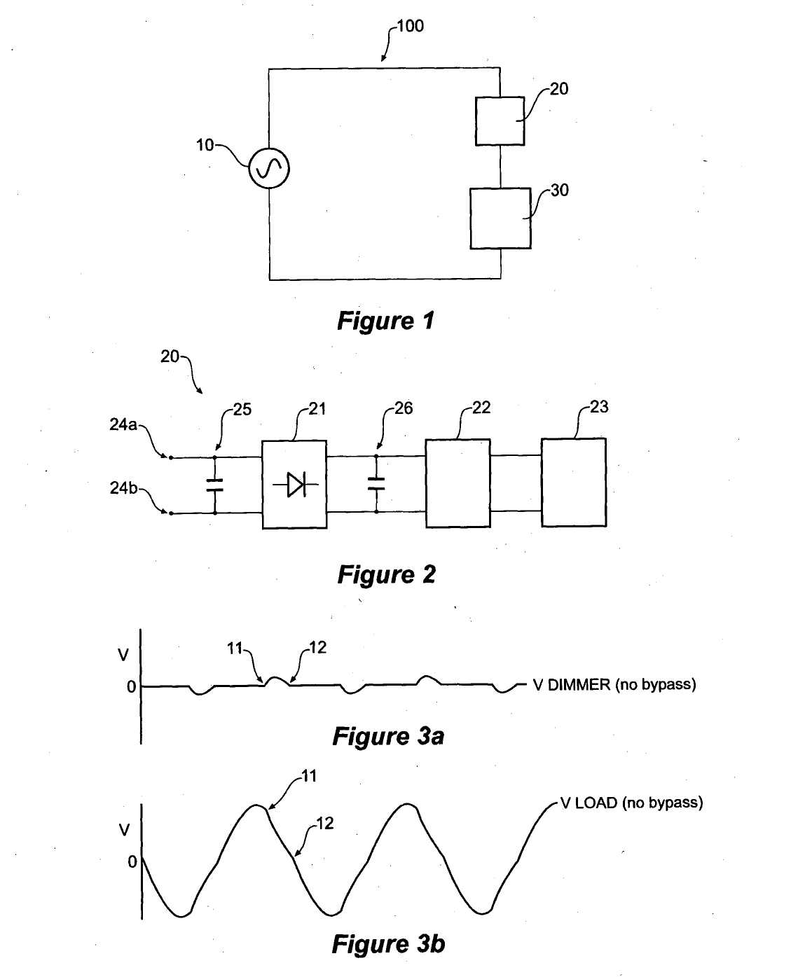

### DETAILED DESCRIPTION

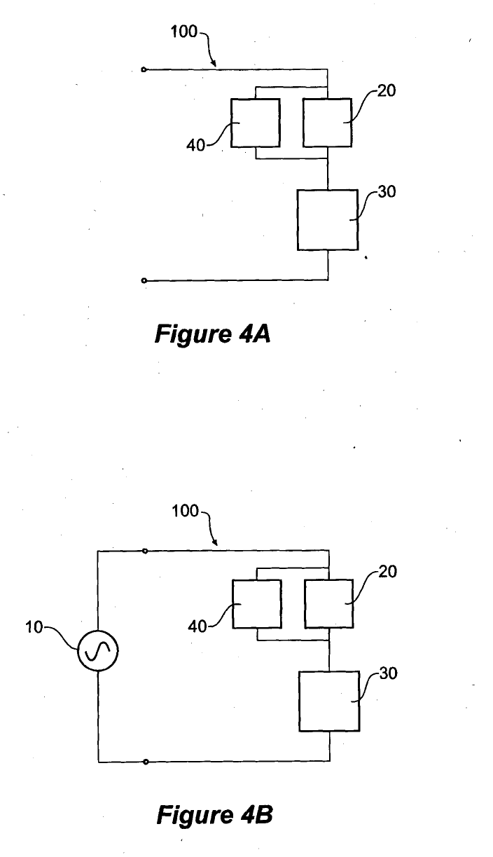

FIG. 4A shows an arrangement for an electrical load control system 100 according to one aspect described herein, for connection to a power source (not shown). Shown there is the electrical load 20 which can comprise an arrangement as shown in FIG. 2 and include an LED, CFL, fan or motor. Connected in series with electrical load 20 is a controller 30. In one embodiment, controller 30 is a phase control dimmer circuit or dimmer. In one embodiment, the controller is a leading edge phase control dimmer. In another embodiment, the controller is a trailing edge phase control dimmer. In one embodiment, the controller is a 2-wire dimmer without a connection to a neutral power line. In another embodiment, the controller is 3-wire dimmer with a connection to the neutral power line. While the details relating to dimmer circuit construction are not the subject of the present disclosure, and will be known to the person skilled in the art, details of a number of specific dimmer circuit configurations are disclosed in the following patent applications: PCT/AU03/00365 entitled “Improved Dimmer Circuit Arrangement”; PCT/AU03/00366 entitled “Dimmer Circuit with Improved Inductive Load”; PCT/AU03/00364 entitled “Dimmer Circuit with Improved Ripple Control”; PCT/AU2006/001883 entitled “Current Zero Crossing Detector in A Dimmer Circuit”; PCT/AU2006/001882 entitled “Load Detector For A Dimmer”; PCT/AU2006/001881 entitled “A Universal Dimmer”; PCT/AU2008/001398 entitled “Improved Start-Up Detection in a Dimmer Circuit”; PCT/AU2008/001399 entitled “Dimmer Circuit With Overcurrent Detection”; and PCT/AU2008/001400 entitled “Overcurrent Protection in a Dimmer Circuit”. The entire content of each of these documents is hereby incorporated by reference.

In other embodiments, controller 30 can be any other suitable device including a metal-oxide-semiconductor field-effect transistor (MOSFET), insulated gate bipolar transistor (IGBT) or silicon-controlled rectifier (SCR).

In parallel with electrical load 20 is bypass device 40. As will be described in more detail below, in one aspect, bypass device 40 is adapted to adopt a low impedance state (high conduction state) when the controller 30 is in a low conduction (high impedance) or off state. This acts to reduce the occurrence of leakage currents through the load 20 when the controller 30 is in a low conduction (high impedance) or off state as will be described in more detail below.

FIG. 4B shows the electrical load control system 100 connected to the power source or supply 10, as it would be connected when in use. Power source 10 will vary from country to country, but in some countries for example, power source 10 is a mains or supply source of about 110V to about 240V at about 50 Hz or about 60 Hz.

In other embodiments, the control system 100 is connected to a portable power source or a local power source independent from a mains grid, such as a backup power source.

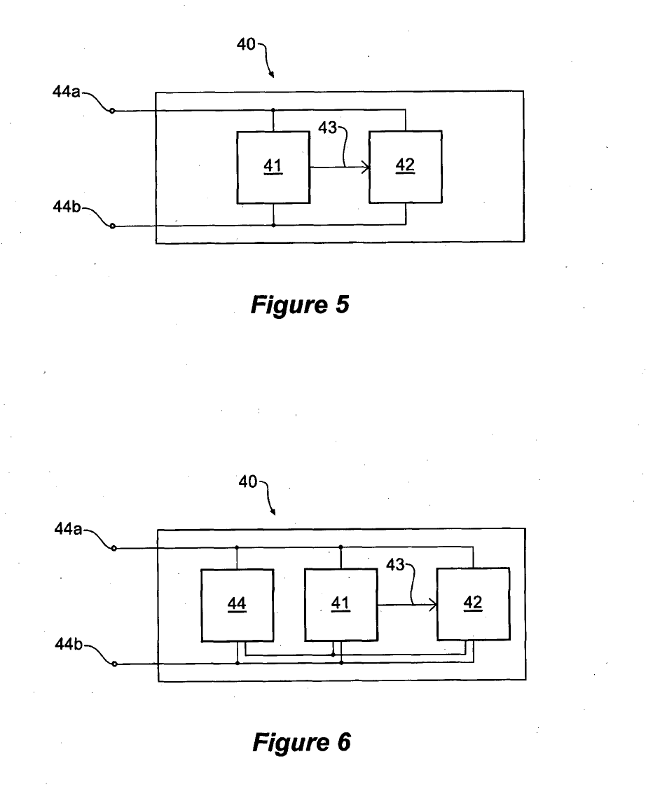

In one embodiment and as shown in FIG. 5, bypass device 40 comprises detector 41 and bypass control 42. In use, detector 41 detects when the controller or dimmer 30 switches from a high conduction state (for example with a resistance typically less than 5 ohms) to a low conduction (for example with a resistance typically more than 100 kohm) or off state. In another embodiment, an example of a high conduction state is resistance less than or equal to about 0.01% of the maximum resistance and an example of a low conduction state means a resistance of greater than or equal to about 90% of the maximum resistance. In other embodiments, a high conduction state is resistance less than or equal to about 0.1% of the maximum resistance and in other embodiments, means a resistance of less than or equal to about 1% of the maximum resistance: In other embodiments still, a high conduction state means a resistance of between about 0.1% and about 5% of the maximum resistance. In other embodiments still, a high conduction state means a resistance of less than about 10% of the maximum resistance.

This detection can be done by many different means as will be described in more detail below. In response to detector 41 detecting that the controller or dimmer 30 has switched to a low conduction or off state, a control signal 43 is generated and provided to bypass control 42. Upon receipt of the control signal 43, bypass control 42 acts to reduce the impedance of bypass device 40 to adopt a low impedance state. In one embodiment, the maximum impedance is about 150 kohms and the minimum impedance is about 1.5 kohm. Thus in one embodiment, minimum impedance is about 1% of the maximum impedance.

In one optional embodiment, detector 41 also detects when the controller or dimmer 30 changes to a high conduction state. In some further embodiments, upon detector 41 detecting that the controller 30 has changed to a high conduction state, bypass control 42 acts to cause bypass device 40 to adopt a low conduction or high impedance state.

FIG. 6 shows another embodiment of the bypass device 40. In this embodiment, bypass device 40 also includes a power supply 44 which provides power to detector 41 and bypass control 42.

In one embodiment, detector 41 detects variations in the electrical signals on terminals 44a and 44b, the results of which provide information on the state of electrical load 20. Using this information, bypass controller 42 acts to limit the voltage across the load/bypass device combination to ensure that the load 20 is completely switched off.

In one embodiment, detector 41 detects high frequency components in the signal at terminals 44a and 44b, generated by controller 30 turning off. Upon detection of these high frequency components, detector 41 generates control signal 43 to cause bypass control 42 to limit the voltage between terminals 44a and 44b to a maximum voltage value. In one embodiment, this maximum voltage value is about 50 volts. In other embodiments, this maximum voltage value is between about 40 volts and about 60 volts.

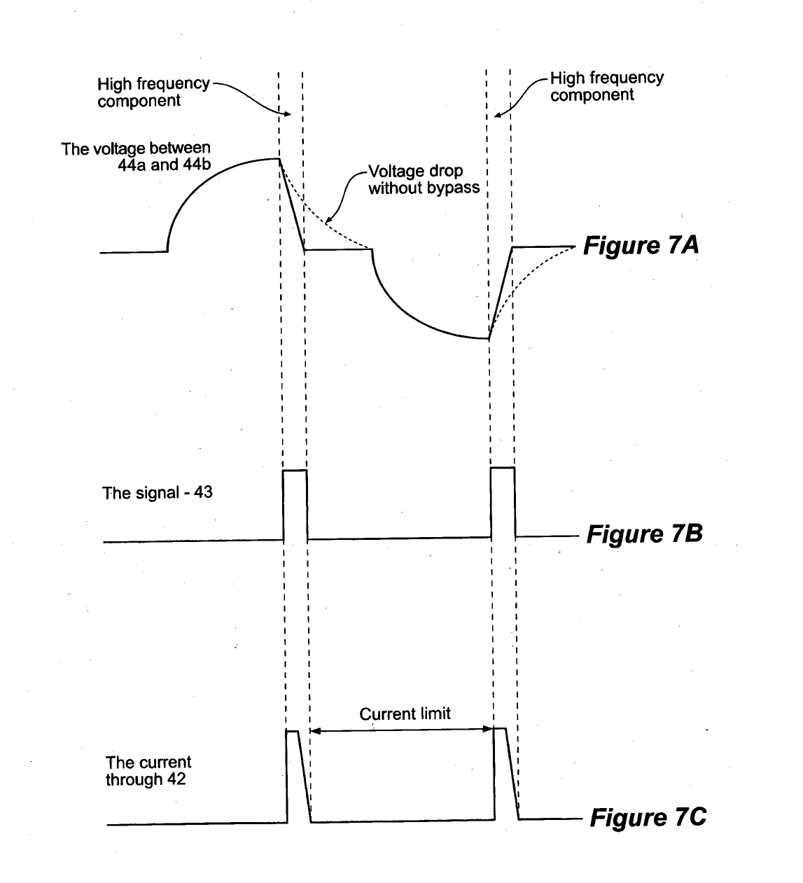

FIG. 7A shows a voltage waveform between terminals 44a and 44b as the controller 30 turns off. In this waveform, the high frequency components described above are shown. FIG. 7B shows the control signal 43 generated by detector 41 upon detection of these high, frequency components. FIG. 7C shows the current limiting through bypass control 42 in response to the control signal 43, thereby limiting the voltage between terminals 44a and 44b.

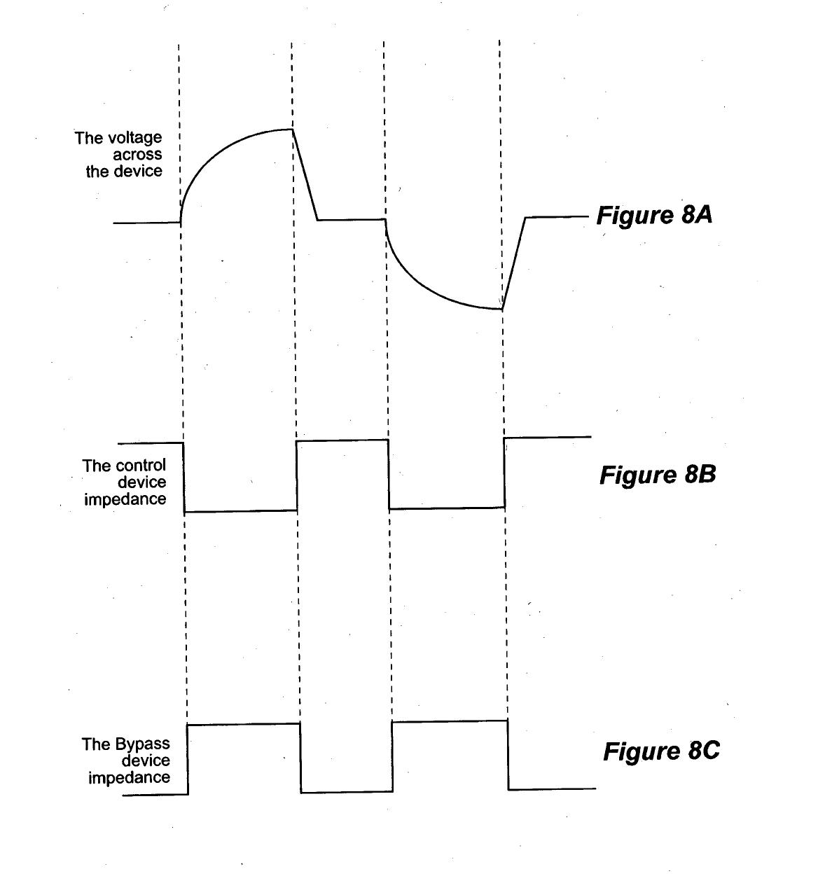

FIG. 8A shows a waveform of the voltage across the bypass device 40 as in FIG. 7A. FIGS. 8B and 8C show the impedance of the controller 30 and the bypass device 40 respectively, as they vary between conduction states. In particular, FIG. 8C shows how the bypass device adopts a low impedance state when the controller 30 is in a low conduction state (or high impedance state, for example off state). FIG. 8C also shows that the bypass device 40 adopts a high impedance state when the controller 30 is in a high conduction (or low impedance state, for example on state).

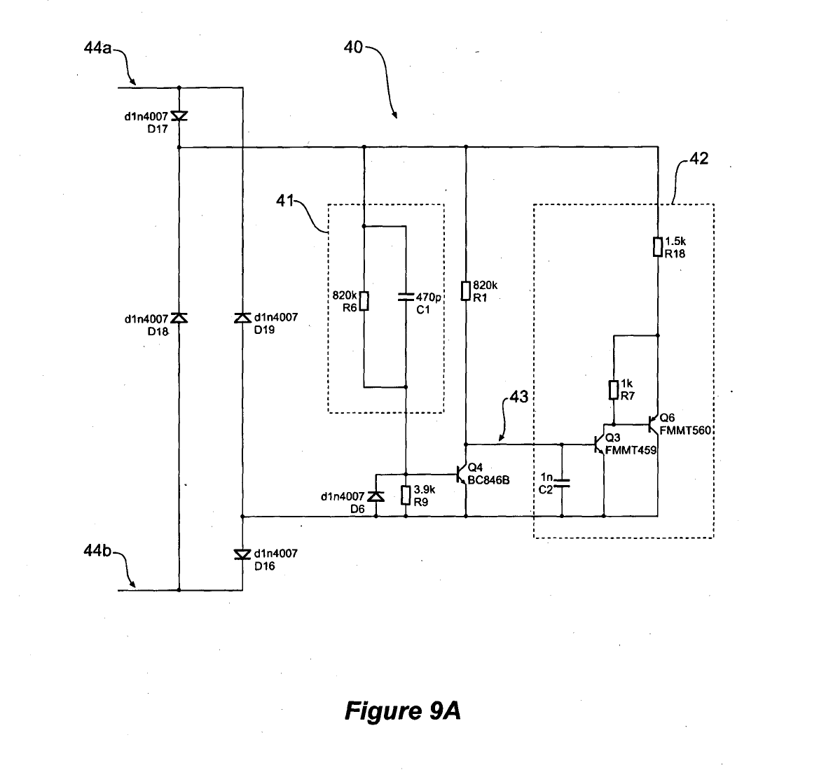

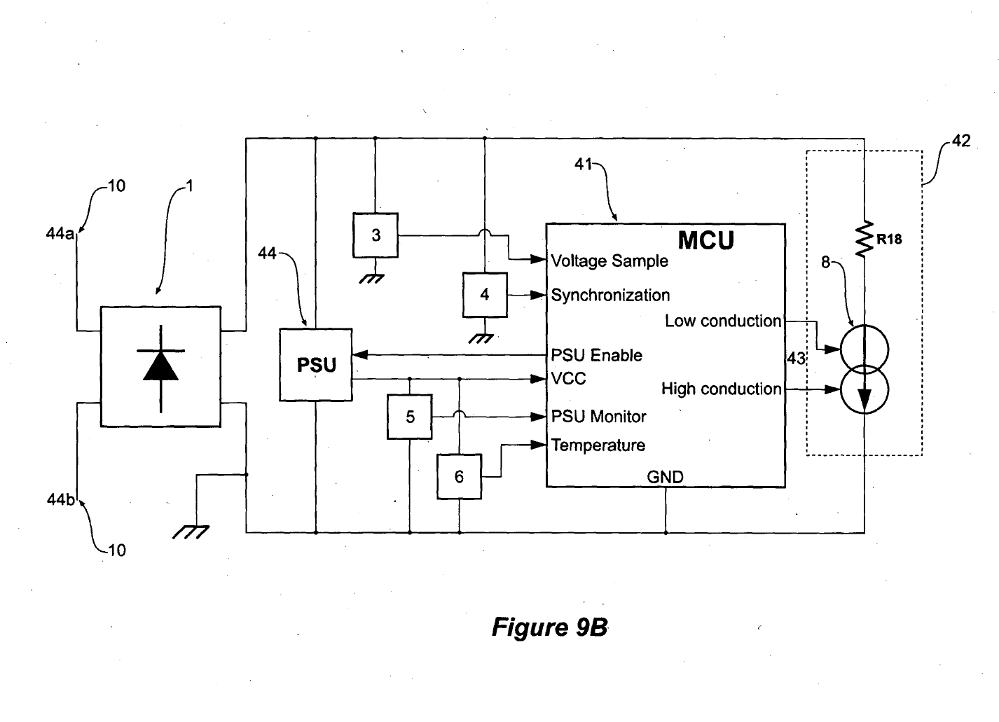

FIG. 9A shows one embodiment of the example described above. In this embodiment, the combination of capacitor C1 and resistor R6 acts as a high pass filter to enable negative going, high frequency components of the voltage between terminals 44a and 44b to turn off transistor Q4, thereby generating control signal 43 that is communicated to bypass control 42 comprising transistors Q3 and Q6 and associated resistor R18. Transistor Q4 is thus switched on for the period that control signal 43 is asserted. Optionally, resistor R18 may be a positive temperature coefficient resistor that also protects the circuit against excessive power dissipation.

In an alternate implementation (not shown) control signal 43 may be latched on and reset only at the beginning of a subsequent mains half cycle. Such an implementation sustains the drive to bypass control 42 for the remaining duration of the cycle.

An additional function of detector 41 that can optionally be used in parallel with the first example described above is also shown in FIG. 9A. The function of this element is to maintain a supply of current to the series bypass device 40 when the voltage across the load 20 is less than a certain, predicated value. In this embodiment, transistor Q4 is switched off when the voltage between the terminals 44a and 44b falls below the predicated value. In one embodiment, the predicated value is about 50V. In another embodiment, the predicated value is between about 40V and about 60V. As described above, the collector of this transistor communicates control signal 43 to bypass control 42 comprising transistors Q3 and Q6 in series with resistor R18. The functionality of this arrangement acts to increase the current flow between terminals 44a and 44b at low voltages, which improves the flow of the power to the controller. Furthermore, this function assists to dampen the resultant ringing of voltage and current generated when the controller 30 is a leading edge mode dimmer circuit that is driving an inductive load.

Power for the functioning of detector 41 and bypass control 42 is either derived internally within the elements or may be supplied by a separate PSU 44. An example of this PSU implementation can be seen in FIG. 9A, comprising diodes D16, D17, D18 and D19. As previously described, these components providing PSU 44 are optional and need not be present, as indicated in FIG. 5.

FIG. 9B shows another embodiment alternative to that of the embodiment of FIG. 9A. In this embodiment, detector 41 is provided in digital form as a microcontroller (for example one provided by Texas Instruments Incorporated, for example in the family of devices identified as MSP430x2xx and as one specific example MSP430F2012). In this embodiment, power supply PSU 44 is provided, and is controlled by the microprocessor/detector 41 to operate efficiently.

In this arrangement, diode bridge (1) rectifies the voltage across the bypass device 40 to allow the bypass device 40 to work for positive and negative half cycles identically when both the power supply current and the discharge current of bypass are conducted through the diode bridge. Block (3) provides mains voltage sampling and feeds this to the microprocessor/detector 41 for use in its operation. Block (4) provides 110V crossing detection for providing trigger signals to detector/microprocessor 41 and block (5) provides circuitry for monitoring the voltage of the power supply 44 reservoir capacitor. Block (6) provides temperature monitoring functionality, while bypass controller 42 is provided by resistor R18 and controlled current source (8).

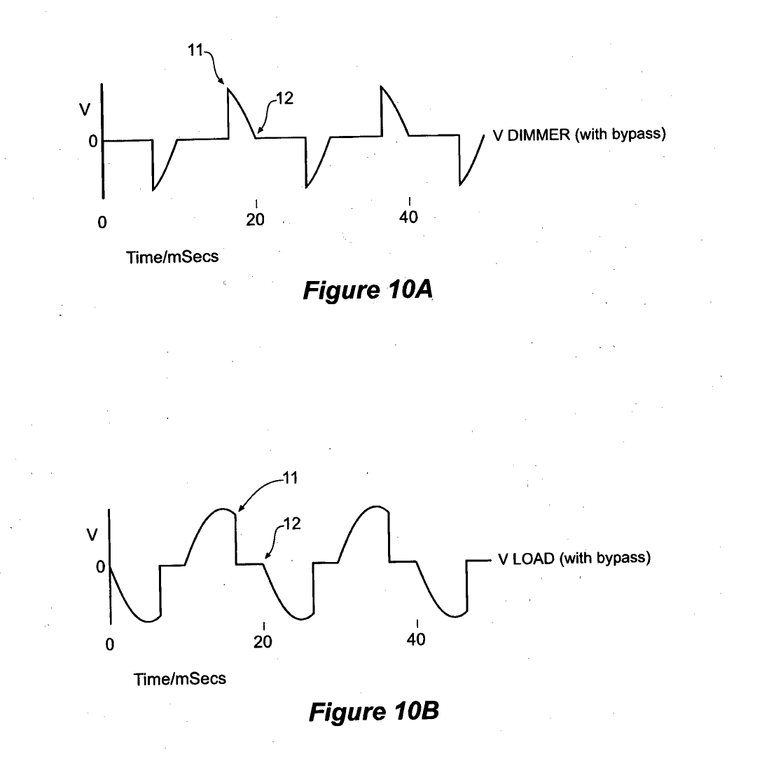

FIGS. 10A and 10B show the change in voltage profiles across the controller or dimmer 30 and electrical load 20 as a result of utilising bypass device 40. These waveforms illustrate the improved delineation of reference points such as zero crossing 12 within the dimmer voltage waveform and can be compared with the waveforms of FIGS. 3A and 3B respectively, where no bypass device 40 is used.

It can be seen that the critical points such as zero-crossing points 12 in the power source waveform are more distinctly defined, which allows the dimmer or controller 30 to more easily detect their presence as will be understood by the person skilled in the art, and thus allow it to function more efficiently. This process also results in an improved availability of internal power of the dimmer or controller 30 thereby enhancing its operation.

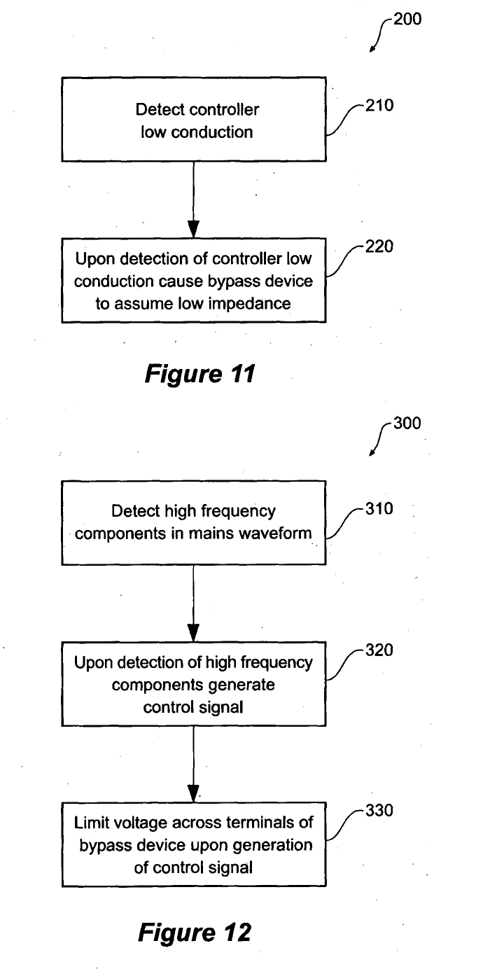

Accordingly, as shown in FIG. 11, there is also provided a general method 200 of controlling an electrical load. In the first step 210, the action of the controller or dimmer, 30 going to a low conduction state is detected. In step 220, upon the detection of the controller or dimmer 30 going into a low conduction state, the bypass device 40 is caused to assume a state of low impedance.

In one embodiment 300 of the general method 200, as shown in FIG. 12, in step 310, detection of the controller or dimmer 30 assuming a low conduction state is performed by detecting high frequency components in the mains waveform. Upon detection of these high frequency components, a control signal is generated in step 320, which then causes, in step 330, bypass controller to limit the voltage across the terminals 44a and 44b of bypass device 40.

It will be appreciated that there are many other methods of detecting when the dimmer or controller 30 has assumed a low or non-conduction state.

One method is to detect the end of conduction by controller or dimmer 30. A number of methods may be used to detect this.

In one embodiment of this method, band limited differentiation of the voltage signal between the terminals 44a and 44b is used.

In another embodiment of this method, the method includes detection of the discontinuity in the voltage signal due to the cessation of conduction.

In another embodiment of this method, detection is made of an impedance change in the circuitry connected to terminals 44a and 44b utilising for example a “challenge” technique wherein an internal test load is switched across terminals 44a and 44b and the subsequent change in voltage is measured.

In another method, use is made of a microprocessor to replace the measurement and timing functions of the bypass device as described above, thereby improving its accuracy and efficiency. Within the microprocessor, predictive techniques can be used whereby measurements in one cycle are used to set the switching times in subsequent cycles (not shown). Optionally such a technique is also able to automatically adjust to changes in conduction times.

In yet another method, use is made of an additional current measurement function external to the invention and typically within the dimmer that communicates a control signal to the bypass device 40 when the current into the load 20 is detected as ceasing.

In yet another method, use is made of a connection mode from the load 20 to the dimmer 30 whereby the load current passes through the bypass device 40 and hence can be used to activate the current shunt function described above.

In yet another method, use is made of an external current measuring means such as a Hall Effect sensor to detect the cessation of current to the load.

Advantages of the various embodiments and aspects described when used in an electrical load power control system include:
a) Prevention of circuit leakage current charging up capacitive elements in the electrical load that otherwise could cause intermittent activation when the dimmer is in the off-state; such activation includes intermittent flashing of the load if it is a Compact Fluorescent or LED lamp.
b) Improved provision of power to the internal control circuitry of the associated dimmer during the full mains cycle regardless of the conduction state of the dimmer.
c) Enhancement of the ability of the associated dimmer to detect reference points on the mains waveform that trigger its switching state transitions.
d) Reduced power consumption relative to the prior art.
e) Reduced physical size relative to the prior art.
f) Reduced Electromagnetic emissions that may otherwise interfere with adjacent electronic equipment
g) Providing an increase in the maximum conduction angle of the dimmer, thereby increasing possible brightness of the load (lamp).The increase in the maximum conduction angle is gained by the basic function of the bypass device which provides a current path to supply the power that the dimmer requires. It will be appreciated that dimmers usually adjust their maximum conduction angle to assure they can receive the power they need to operate. In the case where a capacitive load is connected to a dimmer, the remaining voltage across the capacitance of the load deteriorates the operation of the power supply of the dimmer by reducing the voltage across the dimmer.
The bypass device assists in discharging the capacitance of the load and provides a current path so that the power supply of the dimmer may charge despite connection of a capacitive load
h) Dampening of voltage ringing induced by a dimmer circuit (or controller) driving an inductive load.

The above advantages apply in particular to 2-wire dimmer configurations, items a), d) and e) above also provide advantage to 3-wire dimmer configurations.

It will be appreciated that the above has been described using a number of exemplary embodiments, however the aspects described herein may be carried out by any number of other suitable means within the scope of the following claims.

1. A bypass device configured for use in an electrical load control system having an electrical load and a controller configured to control power provided to the electrical load from a power source, the bypass device configured to be connected in parallel with the electrical load, the bypass device comprising:
a detector configured to detect when the controller is in a low conduction or off state; and
a bypass control configured to cause the bypass device to adopt a low impedance state when the detector detects that the controller is in the low conduction or off state.

2. A bypass device as claimed in claim 1, further comprising: input terminals, wherein the detector comprises a high frequency component detector configured to detect, via the input terminals, high frequency components in a waveform of a voltage signal across the electrical load.

3. A bypass device as claimed in claim 2, wherein the bypass control comprises a voltage limiter configured to limit the voltage across the input terminals of the bypass device to a specified maximum voltage value when the detector detects that the controller is in the low conduction or off state.

4. A bypass device as claimed in claim 1, further comprising: a power source unit configured to provide power to at least one of the detector and the bypass control.

5. A bypass device as claimed in claim 1, wherein the detector is also configured to detect when the controller is in a high conduction or on state and wherein the bypass control is also configured to cause the bypass device to adopt a high impedance state when the controller is in the high conduction or on state.

6. An electrical load control system for controlling power provided to an electrical load, comprising:
an electrical load;
a controller configured to control power provided to the electrical load from a power source; and
a bypass device in parallel with the electrical load, the bypass device configured to adopt a low impedance state when the controller is in a low conduction or off state.

7. An electrical load control system as claimed in claim 6 wherein the bypass device is configured to adopt a high impedance state when the controller is in a high conduction or on state.

8. An electrical load control system as claimed in claim 6, wherein the controller is a phase control dimmer circuit.

9. A method of controlling power delivered to an electrical load in an electrical load control system having the electrical load, a controller configured to control power provided to the electrical load, and a bypass device in parallel with the electrical load, the method comprising;
detecting when the controller is in a low conduction or off state; and
causing the bypass device to adopt a low impedance state when the controller is detected to be in the low conduction or off state.

10. A method as claimed in claim 9, wherein detecting when the controller is in the low conduction or off state includes detecting a presence of high frequency components in a waveform of a power signal across the electrical load.

11. A method as claimed in claim 9, wherein causing the bypass device to adopt the low impedance state includes limiting voltage across input terminals of the bypass device to a maximum voltage value.
